(19) United States
(12) Patent Application Publication
(10) Pub. No.: US 2009/0071332 A1
(43) Pub. Date: Mar. 19, 2009

(54) Management of Hydrogen in Hydorgen-Containing Streams from Hydrogen Sources

(76) Inventors: Bal K. Kaul, Fairfax, VA (US); John W. Viets, Fairfax, VA (US); Mohsen N. Harandi, Calgary (CA); Julian A. Wolfenbarger, Friendswood, TX (US); John Di-Yi Ou, Houston, TX (US); David Stern, Asbury, NJ (US)

Correspondence Address: ExxonMobil Research and Engineering Company, 1545 Route 22 East, P.O. Box 900, Annandale, NJ, 08801-0900, US

(21) Appl. No.: 11/795,548

(22) PCT Filed: Jan. 23, 2006
(86) PCT No.: PCT/US06/02293

§ 371 Date: Nov. 10, 2008

Related U.S. Application Data
(60) Provisional application No. 60/645,713, filed on Jan. 21, 2005.
(60) Provisional application No. 60/752,721, filed on Dec. 21, 2005.

(51) Int. Cl. B01D 53/047

(52) U.S. Cl. 95/96

(57) ABSTRACT

The use of rapid cycle pressure swing adsorption having a cycle time of less than 30 s for increasing the hydrogen concentration in hydrogen-containing steams, from a hydrogen source, such as a stream reforming unit.

### FIELD OF THE INVENTION

This invention relates to an improved hydrotreating process, where the hydrogen is recovered in a rapid cycle pressure swing adsorption having a cycle time of less than one minute for managing hydrogen in hydrogen-containing steams, from a hydrogen source, such as a stream reforming unit.

### BACKGROUND OF THE INVENTION

Hydroprocessing processes are used by petroleum refiners to improve the properties and hence value of many refinery streams. Such hydroprocessing units include hydrotreating, hydrocracking, hydroisomerization and hydrogenation process units. Hydroprocessing is generally accomplished by contacting a hydrocarbon feedstock in a hydroprocessing reaction vessel, or zone, with a suitable hydroprocessing catalyst under hydroprocessing conditions of elevated temperature and pressure in the presence of a hydrogen-containing treat gas to yield an upgraded product having the desired product properties, such as sulfur and nitrogen levels, boiling point, aromatic concentration, pour point and viscosity index. The operating conditions and the hydroprocessing catalysts used will influence the quality of the resulting hydroprocessing products.

All of these hydroprocessing operations require the use of hydrogen, and the amount of hydrogen required to operate these hydroprocessing units has greatly increased for several reasons. Regulatory pressure in the United States, Europe, Asia, and elsewhere has resulted in a trend to increasingly severe and/or selective hydroprocessing processes to form hydrocarbon products having very low levels of sulfur and other tailored properties, such as reduced aromatics levels, and improved pour point and viscosity index. The move to process heavier crude oils and the reduced market for fuel oil is increasing the need for hydrocracking, again leading to a higher hydrogen demand. As the qualities of lubricating oils improve, the need to remove even more sulfur, reduce aromatics levels, and improve pour point and viscosity index have increased the need for hydroprocessing. Further, many refineries receive large amounts of hydrogen as a by-product of catalytic reforming on their site. However, current treads to reduce aromatics in gasoline are constraining the use of catalytic reforming and thus removing a source of hydrogen. Thus, there is an ever growing need for improved hydrogen management associated with the various process units.

Since hydrogen is an important and valuable commodity in the various hydroprocessing units, it would be beneficial if the concentration of hydrogen in hydrogen-containing streams from hydrogen sources can be increased by removing at least a portion of the other components of the hydrogen-containing stream. Hydrogen generating units in a refinery are the steam methane reforming unit, the semiregenerative and continuous regeneration catalytic reformers, and residue gasification. Hydrogen is also produced in the refinery and petrochemical plant in the ethylene cracker, the FCC (Fluidized Catalytic Cracker), and thermal cracking. The relative production data for these sources of hydrogen are set forth in the table below.

TABLE 1

| | | | Wt % on |
|---|---|---|---|
| Process | Wt % on feed | SCF/bbl | crude |
| Continuous regeneration | 3.5 | 1600 | 0.35-0.60 |
| reformer | | | |
| Semiregenerative | 1.4-2.0 | 600-900 | 0.15-0.30 |
| reformer | | | |
| Residue gasification | 20-25 | 12,000-16,000 | 1-5 |
| Catalytic cracking | 0.05-0.10 | 30-60 | 0.01-0.04 |
| Thermal cracking | 0.03 | 20 | 0.01 |
| Ethylene cracker | 0.5-1.2 | — | — |
| Steam (methane) | 30 | 12,000 | — |
| reformer | | | |

Data taken from J. D. Fleshman, “FW Hydrogen Production,” in “Handbook of Petroleum Refining Processes,” 3^{rd} edition, 2004, R. A. Myers editor, McGraw Hill.

Processes for recovering the hydrogen from these hydrogen generation units must match the hydrogen volumes and purities required. A conventional pressure swing adsorption device is typically utilized to recover hydrogen from a steam methane reforming unit or a residua gasification unit, while catalytic reformers typically utilize a separator to remove hydrocarbon condensate from the hydrogen produced. The hydrogen produced in cracking, including thermal, catalytic (i.e., FCC), and ethylene cracking, is not typically recovered due to poor economics. However, it may be advantageous to recover the hydrogen so as to debottleneck the distillative recovery section employed downstream of cracking units for the recovery of light ends, typically referred to as the “wet gas” (C₄-) or “dry gas” (C₂-) recovery trains.

Although there are various processes commercially practiced for recovering hydrogen from these hydrogen generation units, there remains a need in the art for improved technologies to increase the concentration of hydrogen in the various hydrogen-containing treat gas streams used or generated in refining processes.

### SUMMARY OF THE INVENTION

A process wherein the concentration of hydrogen is increased in a hydrogen-containing stream obtained from a hydrogen source, which hydrogen-containing stream contains gaseous components other than hydrogen, which process comprises removing at least a portion of the gaseous components other than hydrogen from said hydrogen-containing stream in a rapid cycle pressure swing adsorption unit containing a plurality of adsorbent beds and having a total cycle time of less than about 30 seconds and a pressure drop within each adsorbent bed of greater than about 5 inches of water per foot of bed length.

In yet another preferred embodiment, the total cycle time or the rapid cycle pressure swing adsorption step is less than about 15 seconds.

In still another preferred embodiment the total cycle time is less than about 10 seconds and the pressure drop is greater than about 10 inches of water per foot of bed length for the rapid cycle pressure swing adsorption step.

### DETAILED DESCRIPTION OF THE INVENTION

The present invention can be practiced on any hydrogen-containing stream obtained from any hydrogen source. The hydrogen source can be a process unit that generates hydrogen as a main product stream or as a side stream. Non-limiting process units that generate hydrogen include steam reformers of methane and light hydrocarbons, residua gasification units, partial oxidation units for light hydrocarbons (POX reactors), catalytic reformers, ethylene crackers, fluid catalytic cracking units, and thermal cracking processes. It is within the scope of this invention that hydrogen-containing streams from other hydrogen generating sources can also be treated in accordance with this invention. Non-limiting examples of such other hydrogen generating sources include: partial oxidation (POX) or reformation of other carbon-based fuels, coal gasification, biomass gasification, pyrolysis, the dissociation of methanol or ammonia, the electrolysis of water, biological photosynthesis and fermentation units, hydrogen bromide electrolysis, photoelectrolysis, and reversible fuel cell technology. This invention is also applicable to hydrogen sources that recover hydrogen from various hydrogen-containing streams, but do not necessarily generate hydrogen. Non-limiting examples of such hydrogen recovery sources include membrane units, cryogenic units and conventional pressure swing adsorption units. The resulting hydrogen-containing product stream from such hydrogen sources is passed to a rapid cycle pressure swing adsorption unit, having cycle times of less than 1 minute, preferably less than about 30 seconds, more preferably less than about 15 seconds, even more preferably less than about 10 seconds, and most preferably less than about 5 seconds.

Steam reforming involves the conversion of methane (and other hydrocarbons in natural gas) into hydrogen and carbon monoxide by reaction with steam over a suitable catalyst, preferably a nickel-based catalyst. Steam reforming generally involves the following steps, as illustrated for methane conversion:
a. Reforming involves methane reacting with steam at elevated temperatures, preferably from about 850° C. to about 900° C. (1560° F.-1740° F.) to produce a synthesis gas (syngas), a mixture primarily made up of hydrogen and carbon monoxide;

CH₄+H₂O----->CO+3H₂
b. Shift Reaction, typically referred to as a water gas shift (WGS) reaction wherein the carbon monoxide that is produced in the first reaction is reacted with steam over a catalyst to form hydrogen and carbon dioxide. This step is usually conducted in two stages consisting of a high temperature shift and a low temperature shift. The high temperature shift is typically performed at about 350° C. (662° F.) and the low temperature shift at about 190° C. to 210° C. (374° F.-410° F.).

CO+H₂O----->CO₂+H₂
c. Hydrogen produced from steam methane reforming typically includes small quantities of carbon monoxide, carbon dioxide, and hydrogen sulfide as impurities and, depending on its intended use, may require further purification. The primary steps for purification is methanation which comprises an exothermic, fixed-bed catalytic reactions of CO and CO₂ with hydrogen at temperatures of about 700° F. to about 800° F. over a nickel on alumina catalyst.

CO+3H₂----->CH₄+H₂O

CO₂+4H₂----->CH₄+2H₂O

Steam reforming typically produces a product stream containing at least about 95 vol. % hydrogen. The concentration of this hydrogen-containing stream can be increased to up to at least about 98 vol. % and preferably to at least about 99 vol. % by the practice of the present invention.

Heavy feeds such as coke and asphalt may also be converted into hydrogen via partial oxidation of the heavy feed to form hydrogen and carbon monoxide at high temperature. Typically, the partial oxidation of asphalt and coke is more favorable as a means to produce electricity, yielding hydrogen as a byproduct.

Light feeds, from refinery gas to naphtha boiling range, can also be partially oxidized by oxygen in catalytic partial oxidation (POX) processing. In this processing mode, more CO is formed relative to steam reforming. This processing mode finds use in generating synthesis gas for petrochemical feedstocks, or as a debottleneck option for existing steam reforming plants.

Catalytic reforming, or hydroforming, is a well-established industrial process employed by the petroleum industry for improving the octane quality of naphthas or straight run gasolines. In reforming, a multi-functional catalyst is employed which contains a metal hydrogenation/dehydrogenation (hydrogen transfer) component, or components, composited with a porous, inorganic oxide support, notably alumina. Platinum metal catalysts, or a catalyst which contains platinum to which one or more additional metal promoters have been added to form polymetallic catalysts, are conventionally employed in conducting reforming operations. In a reforming operation, one or a series of reactors constitute the reforming unit which provides a series of reaction zones. Reforming results in molecular changes, or hydrocarbon reactions, produced by dehydrogenation of cyclohexanes and dehydroisomerization of alkylcyclopentanes to yield aromatics; dehydrogenation of paraffins to yield olefins; dehydrocyclization of paraffins and olefins to yield aromatics; isomerization of n-paraffins; isomerization of alkylcycloparaffins to yield cyclohexanes; isomerization of substituted aromatics; and hydrocracking of paraffins which produces gas, and inevitably coke, the latter being deposited on the catalyst. The recycled hydrogen suppresses, but cannot prevent the build up of coke. Typical process conditions for the catalytic reforming of naphtha streams include temperatures from about 4250 to 650° C., preferably from about 4250 to 540° C.; pressures from about 30 to 300, preferably from about 50 to 200 psig; a weight hourly space velocity from about 0.5 to 20, preferably from about 0.75 to 6.

The reforming process unit can either be comprised of a series of reactors, each containing a fixed-bed of catalyst or in a moving bed reactor. Each reforming reactor in a process unit containing a series of fixed bed reactors is generally provided with a fixed bed, or beds, of the catalyst, wherein each receives down-flow feed, and each is provided with a preheater or interstage heater, because the reactions which take place are endothermic. A naphtha feed, with hydrogen, is concurrently passed through a preheat furnace and reactor, and then in sequence through subsequent interstage heaters and reactors of the series. The product from the last reactor is separated into a C₅+ liquid fraction which is recovered, and a vaporous effluent. The vaporous effluent is a gas rich in hydrogen, and usually contains small amounts of normally gaseous hydrocarbons, from which hydrogen is separated and recycled to the process.

The general principle of operation of a reforming process unit employing a moving bed reactor is that the catalyst is contained in an annular bed formed by spaced cylindrical screens within the reactor. The reactant stream is processed through the catalyst bed, typically in an out-to-in radial flow, that is, it enters the reactor at the top and flows radially from the reactor wall through the annular bed of catalyst which is descending through the reactor, and passes into the cylindrical space created by said annular bed. It exits the bottom of the reforming zone and is passed to a catalyst regeneration zone where it is subjected to one or more steps common to the practice of reforming catalyst regeneration. The catalyst regeneration zone represents all of the steps required to remove at least a portion of the carbon from the catalyst and return it to the state needed for the reforming reactions occurring in the moving-bed reforming zone(s). The specific steps included in catalyst regeneration will vary with the selected catalyst.

Reforming process units employing a series of fixed-bed reactors are well known in the art and are sometimes referred to in accordance to how the catalyst is regenerated, for example cyclic or semi-regenerative. A detailed description of such process units can be found in U.S. Pat. Nos. 4,719,720; 4,992,401 and 5,368,720 which are incorporated herein by reference. Moving-bed reforming zones, or reactors, are well known in the art and are typical of those taught in U.S. Pat. Nos. 3,652,231; 3,856,662; 4,167,473; and 3,992,465 which are also incorporated herein by reference.

The fluid catalytic cracking (FCC) process is well-known. State of the art commercial catalytic cracking catalysts for this process are highly active and selective for converting hydrocarbon charge stocks to liquid fuel products. With such active catalysts it is preferable to conduct catalytic cracking reactions in a dilute phase transport type reaction system with a relatively short period of contact between the catalyst and the hydrocarbon feedstock. In a state of the art process, a regenerated catalyst is fluidized in the lower portion of a riser transport line reactor and mixed with a hydrocarbon charge stock. Hydrocarbon conversion products including a liquid fuel boiling range product, gas and coked catalyst are discharged from the upper end of the riser reactor into a reactor vessel. In the reactor vessel, coked catalyst is separated in a cyclone separator and passed to a stripping section where hydrocarbon vapors are steam stripped from the catalyst. The resulting coke contaminated catalyst, termed spent catalyst, is collected in a spent catalyst standpipe and passed to a vertically arranged regenerator vessel containing a fluidized dense phase catalyst bed. The fluidization is maintained by upwardly flowing oxygen containing regeneration gas introduced by a gas distributor into the lower portion of the dense phase catalyst bed contained in the bottom of the regenerator vessel. Regeneration gas is supplied in excess of that required for complete oxidation of coke as indicated by the analysis of oxygen in flue gas. Above the dense phase catalyst bed is a dilute phase bed wherein residual carbon is oxidized at a temperature higher than in the dense phase bed. Reactivated catalyst, substantially reduced in coke (0.15 wt % or less) is passed vertically upwardly by the fluidizing regeneration gas to an upper portion of the dilute phase bed and into a regenerated catalyst standpipe where it is collected for reuse in the riser reactor. FCC also produces an off gas with a level of hydrogen high enough to warrant separating it from the off-gas, or increasing its concentration in the off gas so that it can be used as at least a portion of a hydrogen-containing treat gas stream to a process unit, such as a hydroprocessing unit in which hydrogen is a reactant.

U.S. Pat. No. 4,481,103 to F. J. Krambeck et al. discloses a fluid catalytic cracking (FCC) process for converting a sulfur containing hydrocarbon charge. Spent catalyst is subjected to steam stripping at a temperature of 500° C. to 700° C. for 1 to 10 minutes in the absence of oxygen. As a result, coke and sulfur are removed from the catalyst.

The thermal cracking of hydrocarbons is the principal route for the industrial production of ethylene, in so called ethylene crackers, via a free radical mechanism. Commercially, the cracking is carried out in tubular reactors, known as pyrolysis coils, in the radiant zone of a furnace. Steam is added to the feed to reduce the formation of coke in the pyrolysis tubes. The temperature of the feed is typically between 500 and 700° C. (930 to 1300° F.), with lower temperatures used for heavier feeds such as atmospheric and vacuum gas oils, and higher temperatures used for light gases such as ethane and propane; depending on the residence time and required severity, the outlet temperature is typically maintained between 775 and 950° C. (1430 to 1740° F.), and the total residence time can range from 0.1 to 1 second. Since the thermal cracking reaction is endothermic, heat is supplied to the pyrolysis tube by the furnace.

The yield of hydrogen from the ethylene cracker varies, and is strongly dependent on the feed used. For lighter feeds such as ethane, hydrogen yields (based on feed) of almost 4% can be realized, while heavier feeds such as butane and vacuum gas oil produce less hydrogen (1 and 0.7%, respectively). Product separation and recovery is typically accomplished in several stages, including: a gasoline fractionator to remove heavy fuel oil cuts, a quench tower, compression, acid gas removal (H₂S, CO₂) with a basic solution, drying over molecular sieves to remove water, and a stripper to remove C₃ and heavier products. In the final stage of product purification, hydrogen is recovered in a cryogenic distillation: by cooling the C₂— stream to −16° C., hydrogen is recovered since H₂ is the only gas at that temperature.

Processes for recovering the hydrogen from these hydrogen generation units must match the hydrogen volumes and purities required. A conventional pressure swing adsorption device is typically utilized to recover hydrogen from a steam methane reforming unit or a residua gasification unit, while catalytic reformers typically utilize a separator to remove hydrocarbon condensate from the hydrogen produced. The hydrogen produced in cracking, including thermal, catalytic (i.e., FCC), and ethylene cracking, is not typically recovered due to poor economics. However, it may be advantageous to recover the hydrogen so as to debottleneck the distillative recovery section employed downstream of cracking units for the recovery of light ends, typically referred to as the “wet gas” (C₄⁻) or “dry gas” (C₂⁻) recovery trains.

Hydrogen-containing streams from units that recover hydrogen from other streams in a petroleum refinery or petrochemical plant can also be treated in accordance with the present invention to increase hydrogen concentration. Non-limiting examples of such sources include cryogenic units, membrane units, and conventional pressure swing adsorption units. Wet scrubbing is commonly used to remove acid gases, such as H2S and CO2. The process involves passing the gaseous stream through an amine or a potassium carbonate system. Membrane units for hydrogen recovery take advantage of the different diffusivity of hydrogen versus other contaminants though a membrane. Hydrogen, the permeate through the membrane, is produced at low pressure. Cryogenic separation operates by cooling the gas feedstream, so as to condense a fraction of the feed, followed by separation via either flashing or distillation. This type of separation is typically employed to recover light olefins from the FCC offgas, and finds use in ethylene crackers. Hydrogen recovery from cryogenic distillation is typically 95%, with 98% purity. Clearly, any of these processes, or combinations thereof, can be used to recover hydrogen.

In Conventional Pressure Swing Adsorption (“conventional PSA”) a gaseous mixture is conducted under pressure for a period of time over a first bed of a solid sorbent that is selective or relatively selective for one or more components, usually regarded as a contaminant that is to be removed from the gas stream. It is possible to remove two or more contaminants simultaneously but for convenience, the component or components that are to be removed will be referred to in the singular and referred to as a contaminant. The gaseous mixture is passed over a first adsorption bed in a first vessel and emerges from the bed depleted in the contaminant that remains sorbed in the bed. After a predetermined time or, alternatively when a break-through of the contaminant is observed, the flow of the gaseous mixture is switched to a second adsorption bed in a second vessel for the purification to continue. While the second bed is in adsorption service, the sorbed contaminant is removed from the first adsorption bed by a reduction in pressure, usually accompanied by a reverse flow of gas to desorb the contaminant. As the pressure in the vessels is reduced, the contaminant previously adsorbed on the bed is progressively desorbed into the tail gas system that typically comprises a large tail gas drum, together with a control system designed to minimize pressure fluctuations to downstream systems. The contaminant can be collected from the tail gas system in any suitable manner and processed further or disposed of as appropriate. When desorption is complete, the sorbent bed may be purged with an inert gas stream, e.g., nitrogen or a purified stream of the process gas. Purging may be facilitated by the use of a higher temperature purge gas stream.

After, e.g., breakthrough in the second bed, and after the first bed has been regenerated so that it is again prepared for adsorption service, the flow of the gaseous mixture is switched from the second bed to the first bed, and the second bed is regenerated. The total cycle time is the length of time from when the gaseous mixture is first conducted to the first bed in a first cycle to the time when the gaseous mixture is first conducted to the first bed in the immediately succeeding cycle, i.e., after a single regeneration of the first bed. The use of third, fourth, fifth, etc. vessels in addition to the second vessel, as might be needed when adsorption time is short but desorption time is long, will serve to increase cycle time.

Thus, in one configuration, a pressure swing cycle will include a feed step, at least one depressurization step, a purge step, and finally a repressurization step to prepare the adsorbent material for reintroduction of the feed step. The sorption of the contaminants usually takes place by physical sorption onto the sorbent that is normally a porous solid such as activated carbon, alumina, silica or silica-alumina that has an affinity for the contaminant. Zeolites are often used in many applications since they may exhibit a significant degree of selectivity for certain contaminants by reason of their controlled and predictable pore sizes. Normally, chemical reaction with the sorbent is not favored in view of the increased difficulty of achieving desorption of species which have become chemically bound to the sorbent, but chemisorption is my no means to be excluded if the sorbed materials may be effectively desorbed during the desorption portion of the cycle, e.g., by the use of higher temperatures coupled with the reduction in pressure. Pressure swing adsorption processing is described more fully in the book entitled Pressure Swing Adsorption, by D. M. Ruthven, S. Farouq & K. S. Knaebel (VCH Publishers, 1994).

Conventional PSA possesses significant inherent disadvantages for a variety of reasons. For example, conventional PSA units are costly to build and operate and are significantly larger in size for the same amount of hydrogen that needs to be recovered from hydrogen-containing gas streams as compared to RCPSA. Also, a conventional pressure swing adsorption unit will generally have cycle times in excess of one minute, typically in excess of 2 to 4 minutes due to time limitations required to allow diffusion of the components through the larger beds utilized in conventional PSA and the equipment configuration and valving involved. In contrast, rapid cycle pressure swing adsorption is utilized which has total cycle times of less than one minute. The total cycle times of RCPSA may be less than 30 seconds, preferably less than 15 seconds, more preferably less than 10 seconds, even more preferably less than 5 seconds, and even more preferably less 2 seconds. Further, the rapid cycle pressure swing adsorption units used can make use of substantially different sorbents, such as, but not limited to, structured materials such as monoliths.

The overall adsorption rate of the adsorption processes, whether conventional PSA or RCPSA, is characterized by the mass transfer rate constant in the gas phase (τ_{g}) and the mass transfer rate constant in the solid phase (τₛ). A material's mass transfer rates of a material are dependent upon the adsorbent, the adsorbed compound, the pressure and the temperature. The mass transfer rate constant in the gas phase is defined as:

τ_{g}=D_{g}/R_{g}² (in cm²/sec) (1)

where D_{g} is the diffusion coefficient in the gas phase and R_{g} is the characteristic dimension of the gas medium. Here the gas diffusion in the gas phase, D_{g}, is well known in the art (i.e., the conventional value can be used) and the characteristic dimension of the gas medium, R_{g} is defined as the channel width between two layers of the structured adsorbent material.

The mass transfer rate constant in the solid phase of a material is defined as:

τₛ=Dₛ/Rₛ² (in cm²/sec) (2)

where Dₛ is the diffusion coefficient in the solid phase and Rₛ is the characteristic dimension of the solid medium. Here the gas diffusion coefficient in the solid phase, Dₛ, is well known in the art (i.e., the conventional value can be used) and the characteristic dimension of the solid medium, Rₛ is defined as the width of the adsorbent layer.

D. M. Ruthven & C. Thaeron, Performance of a Parallel Passage Absorbent Contactor, Separation and Purification Technology 12 (1997) 43-60, which is incorporated by reference, clarifies that for flow through a monolith or a structured adsorbent that channel width is a good characteristic dimension for the gas medium, R_{g}. U.S. Pat. No. 6,607,584 to Moreau et al., which is incorporated by reference, also describes the details for calculating these transfer rates and associated coefficients for a given adsorbent and the test standard compositions used for conventional PSA. Calculation of these mass transfer rate constants is well known to one of ordinary skill in the art and may also be derived by one of ordinary skill in the art from standard testing data.

Conventional PSA relies on the use of adsorbent beds of particulate adsorbents. Additionally, due to construction constraints, conventional PSA is usually comprised of 2 or more separate beds that cycle so that at least one or more beds is fully or at least partially in the feed portion of the cycle at any one time in-order to limit disruptions or surges in the treated process flow. However, due to the relatively large size of conventional PSA equipment, the particle size of the adsorbent material is general limited particle sizes of about 1 mm and above. Otherwise, excessive pressure drop, increased cycle times, limited desorption, and channeling of feed materials will result.

In an embodiment, RCPSA utilizes a rotary valving system to conduct the gas flow through a rotary sorber module that contains a number of separate adsorbent bed compartments or “tubes”, each of which is successively cycled through the sorption and desorption steps as the rotary module completes the cycle of operations. The rotary sorber module is normally comprised of multiple tubes held between two seal plates on either end of the rotary sorber module wherein the seal plates are in contact with a stator comprised of separate manifolds wherein the inlet gas is conducted to the RCPSA tubes and processed purified product gas and the tail gas exiting the RCPSA tubes is conducted away from rotary sorber module. By suitable arrangement of the seal plates and manifolds, a number of individual compartments or tubes may pass through the characteristic steps of the complete cycle at any one time. In contrast with conventional PSA, the flow and pressure variations required for the RCPSA sorption/desorption cycle changes in a number of separate increments on the order of seconds per cycle, which smoothes out the pressure and flow rate pulsations encountered by the compression and valving machinery. In this form, the RCPSA module includes valving elements angularly spaced around the circular path taken by the rotating sorption module so that each compartment is successively passed to a gas flow path in the appropriate direction and pressure to achieve one of the incremental pressure/flow direction steps in the complete RCPSA cycle. One key advantage of the RCPSA technology is a significantly more efficient use of the adsorbent material. The quantity of adsorbent required with RCPSA technology can be only a fraction of that required for conventional PSA technology to achieve the same separation quantities and qualities. As a result, the footprint, investment, and the amount of active adsorbent required for RCPSA is significantly lower than that for a conventional PSA unit processing an equivalent amount of gas.

In an embodiment, RCPSA bed length unit pressure drops, required adsorption activities, and mechanical constraints (due to centrifugal acceleration of the rotating beds in RCPSA), prevent the use of many conventional PSA adsorbent bed materials, in particular adsorbents that are in a loose pelletized, particulate, beaded, or extrudate form. In a preferred embodiment, adsorbent materials are secured to a supporting understructure material for use in an RCPSA rotating apparatus. For example, one embodiment of the rotary RCPSA apparatus can be in the form of adsorbent sheets comprising adsorbent material coupled to a structured reinforcement material. A suitable binder may be used to attach the adsorbent material to the reinforcement material. Non-limiting examples of reinforcement material include monoliths, a mineral fiber matrix, (such as a glass fiber matrix), a metal wire matrix (such as a wire mesh screen), or a metal foil (such as aluminum foil), which can be anodized. Examples of glass fiber matrices include woven and non-woven glass fiber scrims. The adsorbent sheets can be made by coating a slurry of suitable adsorbent component, such as zeolite crystals with binder constituents onto the reinforcement material, non-woven fiber glass scrims, woven metal fabrics, and expanded aluminum foils. In a particular embodiment, adsorbent sheets or material are coated onto ceramic supports.

An absorber in a RCPSA unit typically comprises an adsorbent solid phase formed from one or more adsorbent materials and a permeable gas phase through which the gases to be separated flow from the inlet to the outlet of the adsorber, with a substantial portion of the components desired to be removed from the stream adsorbing onto the solid phase of the adsorbent. This gas phase may be called “circulating gas phase”, but more simply “gas phase”. The solid phase includes a network of pores, the mean size of which is usually between approximately 0.02 μm and 20 μm. There may be a network of even smaller pores, called “micropores”, this being encountered, for example, in microporous carbon adsorbents or zeolites. The solid phase may be deposited on a non-adsorbent support, the primary function of which is to provide mechanical strength for the active adsorbent materials and/or provide a thermal conduction function or to store heat. The phenomenon of adsorption comprises two main steps, namely passage of the adsorbate from the circulating gas phase onto the surface of the solid phase, followed by passage of the adsorbate from the surface to the volume of the solid phase into the adsorption sites.

In an embodiment, RCPSA utilizes a structured adsorbent which is incorporated into the tubes utilized in the RSPCA apparatus. These structured adsorbents have an unexpectedly high mass transfer rate since the gas flows through the channels formed by the structured sheets of the adsorbent which offers a significant improvement in mass transfer as compared to a traditional packed fixed bed arrangement as utilized in conventional PSA. The ratio of the transfer rate of the gas phase (τ_{g}) and the mass transfer rate of the solid phase (τₛ) in the current invention is greater than 10, preferably greater than 25, more preferably greater than 50. These extraordinarily high mass transfer rate ratios allow RCPSA to produce high purity hydrogen streams at high recovery rates with only a fraction of the equipment size, adsorbent volume, and cost of conventional PSA.

The structured adsorbent embodiments also results in significantly greater pressure drops to be achieved through the adsorbent than conventional PSA without the detrimental effects associated with particulate bed technology. The adsorbent beds can be designed with adsorbent bed unit length pressure drops of greater than 5 inches of water per foot of bed length, more preferably greater than 10 in. H₂O/ft, and even more preferably greater than 20 in. H₂O/ft. This is in contrast with conventional PSA units where the adsorbent bed unit length pressure drops are generally limited to below about 5 in. H₂O/ft depending upon the adsorbent used, with most conventional PSA units being designed with a pressure drop of about 1 in. H₂O/ft or less to minimize the problems discussed that are associated with the larger beds, long cycle time, and particulate absorbents of conventional PSA units. The adsorbent beds of conventional PSA cannot accommodate higher pressure drops because of the risk of fluidizing the beds which results in excessive attrition and premature unit shutdowns due to accompanying equipment problems and/or a need to add or replace lost adsorbent materials. These markedly higher adsorbent bed unit length pressure drops allow RCPSA adsorbent beds to be significantly more compact, shorter, and efficient than those utilized in conventional PSA.

In an embodiment, high unit length pressure drops allow high vapor velocities to be achieved across the structured adsorbent beds. This results in a greater mass contact rate between the process fluids and the adsorbent materials in a unit of time than can be achieved by conventional PSA. This results in shorter bed lengths, higher gas phase transfer rates (τ_{g}) and improved hydrogen recovery. With these significantly shorter bed lengths, total pressure drops of the RSCPA application of the present invention can be maintained at total bed pressure differentials during the feed cycle of about 0.5 to 50 psig, preferably less than 30 psig, while minimizing the length of the active beds to normally less than 5 feet in length, preferably less than 2 feet in length and as short as less than 1 foot in length.

The absolute pressure levels employed during the RCPSA process are not critical. In practice, provided that the pressure differential between the adsorption and desorption steps is sufficient to cause a change in the adsorbate fraction loading on the adsorbent thereby providing a delta loading effective for separating the stream components processed by the RCPSA unit. Typical absolute operating pressure levels range from about 50 to 2500 psia. However, it should be noted that the actual pressures utilized during the feed, depressurization, purge and repressurization stages are highly dependent upon many factors including, but not limited to, the actual operating pressure and temperature of the overall stream to be separated, stream composition, and desired recovery percentage and purity of the RCPSA product stream. The RCPSA process is not specifically limited to any absolute pressure and due to its compact size becomes incrementally more economical than conventional PSA processes at the higher operating pressures. U.S. Pat. Nos. 6,406,523; 6,451,095; 6,488,747; 6,533,846 and 6,565,635, all of which are incorporated herein by reference, disclose various aspects of RCPSA technology.

In an embodiment and an example, the rapid cycle pressure swing adsorption system has a total cycle time, t_{TOT}, to separate a feed gas into product gas (in this case, a hydrogen-enriched stream) and a tail (exhaust) gas. The method generally includes the steps of conducting the feed gas having a hydrogen purity F %, where F is the percentage of the feed gas which is the weakly-adsorbable (hydrogen) component, into an adsorbent bed that selectively adsorbs the tail gas and passes the hydrogen product gas out of the bed, for time, t_{F}, wherein the hydrogen product gas has a purity of P % and a rate of recovery of R %. Recovery R % is the ratio of amount of hydrogen retained in the product to the amount of hydrogen available in the feed. Then the bed is co-currently depressurized for a time, t_{CO}, followed by counter-currently depressurizing the bed for a time, t_{CN}, wherein desorbate (tail gas or exhaust gas) is released from the bed at a pressure greater than or equal to 1 psig. The bed is purged for a time, t_{P}, typically with a portion of the hydrogen product gas. Subsequently the bed is repressurized for a time, t_{RP}, typically with a portion of hydrogen product gas or feed gas, wherein the cycle time, t_{TOT}, is equal to the sum of the individual cycle times comprising the total cycle time, i.e.:

t_{TOT}=t_{F}+t_{CO}+t_{CN}+t_{P}+t_{RP} (3)

This embodiment encompasses, but is not limited to, RCPSA processes such that either the rate of recovery, R %>80% for a product purity to feed purity ratio, P %/F %>1.1, and/or the rate of recovery, R %>90% for a product purity to feed purity ratio, 0<P %/F %<1.1. Results supporting these high recovery & purity ranges can be found in Examples 4 through 10 herein. Other embodiments will include applications of RCPSA in processes where hydrogen recovery rates are significantly lower than 80%. Embodiments of RCPSA are not limited to exceeding any specific recovery rate or purity thresholds and can be as applied at recovery rates and/or purities as low as desired or economically justifiable for a particular application.

It should also be noted that it is within the scope of this invention that steps t_{CO}, t_{CN}, or t_{P} of equation (3) above can be omitted together or in any individual combination. However it is preferred that all steps in the above equation (3) be performed or that only one of steps t_{CO} or t_{CN} be omitted from the total cycle. However, additional steps can also be added within a RCPSA cycle to aid in enhancing purity and recovery of hydrogen. Thus enhancement could be practically achieved in RCPSA because of the small portion of absorbent needed and due to the elimination of a large number of stationary valves utilized in conventional PSA applications.

In an embodiment, the tail gas is also preferably released at a pressure high enough so that the tail gas may be fed to another device absent tail gascompression. More preferably the tail gas pressure is greater than or equal to 60 psig. In a most preferred embodiment, the tail gas pressure is greater than or equal to 80 psig. At higher pressures, the tail gas can be conducted to a fuel header.

Practice of the present invention can have the following benefits:

Increasing the purity of hydrogen-containing stream(s) available as makeup gas, or of streams which must be upgraded to higher purity before they are suitable as make-up gas.

Increasing the purity of hydrogen-containing recycle gas streams resulting in an increase in overall hydrogen treat gas purity in the hydrotreating reactors to allow for higher hydrotreating severity or additional product treating.

Use for H₂ recovery from hydroprocessing purge gases, either where significant concentrations of H₂S are present (before gas scrubbing) or after gas scrubbing (typically <100 vppm H₂S).

In hydroprocessing, increased H₂ purity translates to higher H₂ partial pressures in the hydroprocessing reactor(s). This both increases the reaction kinetics and decreases the rate of catalyst deactivation. The benefits of higher H₂ partial pressures can be exploited in a variety of ways, such as: operating at lower reactor temperature, which reduces energy costs, decreases catalyst deactivation, and extends catalyst life; increasing unit feed rate; processing more sour (higher sulfur) feedstocks; processing higher concentrations of cracked feedstocks; improved product color, particularly near end of run; debottlenecking existing compressors and/or treat gas circuits (increased scf H₂ at constant total flow, or same scf H₂ at lower total flow); and other means that would be apparent to one skilled in the art.

Increased H₂ recovery also offers significant potential benefits, some of which are described as follows:

(i) reducing the demand for purchased, manufactured, or other sources of H₂ within the refinery;

(ii) increasing hydroprocessing feed rates at constant (existing) makeup gas demands as a result of the increased hydrogen recovery;

(iii) improving the hydrogen purity in hydroprocessing for increased heteroatom removal efficiencies;

(iv) removing a portion of the H₂ from refinery fuel gas which is detrimental to the fuel gas due to hydrogen's low BTU value which can present combustion capacity limitations and difficulties for some furnace burners;

(v) Other benefits that would be apparent to one knowledgeable in the art.

The following examples are presented for illustrative purposes only and should not be cited as being limiting in any way.

### EXAMPLE 1

In this example, the refinery stream is at 480 psig with tail gas at 65 psig whereby the pressure swing is 6.18. The feed composition and pressures are typical of refinery processing units such as those found in hydroprocessing or hydrotreating applications. In this example typical hydrocarbons are described by their carbon number i.e. C₁=methane, C₂=ethane etc. The RCPSA is capable of producing hydrogen at >99% purity and >81% recovery over a range of flow rates. Tables 2a and 2b show the results of computer simulation of the RCPSA and the input and output percentages of the different components for this example. Tables 2a and 2b also show how the hydrogen purity decreases as recovery is increased from 89.7% to 91.7% for a 6 MMSCFD stream at 480 psig and tail gas at 65 psig.

### Tables 2a & 2b

Composition (mol %) of input and output from RCPSA (67 ft³) in H2 purification. Feed is at 480 psig, 122 deg F. and Tail gas at 65 psig. Feed rate is about 6 MMSCFD.

TABLE 2a
Higher purity
Step Times in seconds are t_{F} = 1, t_{CO} = 0.167, t_{CN} = 0,
t_{P} = 0.333, t_{RP} = 0.5
H2 at 98.6% purity, 89.7% recovery

| | FEED | PRODUCT | TAIL-GAS |
|---|---|---|---|
| H2 | 88.0 | 98.69 | 45.8 |
| C1 | 6.3 | 1.28 | 25.1 |
| C2 | 0.2 | 0.01 | 1.0 |
| C3 | 2.6 | 0.01 | 12.3 |
| C4+ | 2.9 | 0.00 | 14.8 |
| H2O | 2000 vppm | 65 vppm | 9965 vppm |
| TOTAL (MMSCFD) | 6.162 | 4.934 | 1.228 |
| | 480 psig | 470 psig | 65 psig |

TABLE 2b
Higher purity
Step Times in seconds are t_{F} = 1, t_{CO} = 0.333, t_{CN} = 0,
t_{P} = 0.167, t_{RP} = 0.5
H2 at 97.8% purity, 91.7% recovery

| | FEED | PRODUCT | TAIL-GAS |
|---|---|---|---|
| H2 | 88.0 | 97.8 | 45.9 |
| C1 | 6.3 | 2.14 | 25.0 |
| C2 | 0.2 | 0.02 | 1.0 |
| C3 | 2.6 | 0.02 | 12.3 |
| C4+ | 2.9 | 0.00 | 14.9 |
| H2O | 2000 vppm | 131 vppm | 10016 vpm |
| TOTAL (MMSCFD) | 6.160 | 5.085 | 1.074 |
| | 480 psig | 470 psig | 65 psig |

The RCPSA's described in the present invention operate a cycle consisting of different steps. Step 1 is feed during which product is produced, step 2 is co-current depressurization, step 3 is counter-current depressurization, step 4 is purge, usually counter-current) and step 5 is repressurization with product. In the RCPSA's described here at any instant half the total number of beds are on the feed step. In this example, t_{TOT}=2 sec in which the feed time, t_{F}, is one-half of the total cycle.

### EXAMPLE 2

In this example, the conditions are the same as in Example 1. Table 3a shows conditions utilizing both a co-current and counter-current steps to achieve hydrogen purity >99%. Table 3b shows that the counter-current depressurization step may be eliminated, and a hydrogen purity of 99% can still be maintained. In fact, this shows that by increasing the time of the purge cycle, tp, by the duration removed from the counter-current depressurization step, t_{CN}, that hydrogen recovery can be increased to a level of 88%.

### Tables 3a & 3b

Effect of step durations on H2 purity and recovery from an RCPSA (67 ft³). Same conditions as Table 2. Feed is at 480 psig, 122 deg F. and Tail gas at 65 psig. Feed rate is about 6 MMSCFD.

TABLE 3a
With counter-current depress, Intermediate pressure = 105 psig.

| Purity | Recovery | t_{F} | t_{CO} | t_{CN} | t_{P} | t_{RP} |
|---|---|---|---|---|---|---|
| % | % | s | S | s | S | S |
| 98.2 | 84.3 | 1 | 0.283 | 0.05 | 0.167 | 0.5 |
| 98.3 | 85 | 1 | 0.166 | 0.167 | 0.167 | 0.5 |
| 99.9 | 80 | 1 | 0.083 | 0.25 | 0.167 | 0.5 |

TABLE 3b
Without counter-current depress

| Purity | Recovery | t_{F} | t_{CO} | t_{CN} | t_{P} | t_{RP} |
|---|---|---|---|---|---|---|
| % | % | s | S | s | S | s |
| 97.8 | 91.7 | 1 | 0.333 | 0 | 0.167 | 0.5 |
| 98.7 | 90 | 1 | 0.166 | 0 | 0.334 | 0.5 |
| 99 | 88 | 1 | 0.083 | 0 | 0.417 | 0.5 |

### EXAMPLE 3

This example shows a 10 MMSCFD refinery stream, once again containing typical components, as shown in feed column of Table 4 (e.g. the feed composition contains 74% H₂). The stream is at 480 psig with RCPSA tail gas at 65 psig whereby the absolute pressure swing is 6.18. Once again the RCPSA of the present invention is capable of producing hydrogen at >99% purity and >85% recovery from these feed compositions. Tables 4a and 4b show the results of this example.

### Tables 4a & 4b

Composition (mol %) of input and output from RCPSA (53 ft³) in H2 purification. Feed is at 480 psig, 101 deg F. and Tail gas at 65 psig. Feed rate is about 10 MMSCFD.

TABLE 4a
Higher purity
Step Times in seconds are t_{F} = 0.583, t_{CO} = 0.083, t_{CN} = 0,
t_{P} = 0.25, t_{RP} = 0.25
H2 at 99.98% purity and 86% recovery

| | FEED | PRODUCT | TAIL-GAS |
|---|---|---|---|
| H2 | 74.0 | 99.98 | 29.8 |
| C1 | 14.3 | 0.02 | 37.6 |
| C2 | 5.2 | 0.00 | 13.8 |
| C3 | 2.6 | 0.00 | 7.4 |
| C4+ | 3.9 | 0.00 | 11.0 |
| H2O | 2000 vppm | 0.3 vppm | 5387 vppm |
| TOTAL (MMSCFD) | 10.220 | 6.514 | 3.705 |
| | 480 psig | 470 psig | 65 psig |

TABLE 4b
Lower purity
Step Times in seconds are t_{F} = 0.5, t_{CO} = 0.167, t_{CN} = 0,
t_{P} = 0.083, t_{RP} = 0.25
H2 at 93% purity and 89% recovery

| | FEED | PRODUCT | TAIL-GAS |
|---|---|---|---|
| H2 | 74.0 | 93.12 | 29.3 |
| C1 | 14.3 | 6.34 | 31.0 |
| C2 | 5.2 | 0.50 | 16.6 |
| C3 | 2.6 | 0.02 | 8.9 |
| C4+ | 3.9 | 0.00 | 13.4 |
| H2O | 2000 vppm | 142 vppm | 6501 vppm |
| TOTAL (MMSCFD) | 10.220 | 7.240 | 2.977 |
| | 480 psig | 470 psig | 65 psig |

In both cases shown in Table 4a and 4b above, although tail gas pressure is high at 65 psig, the present invention shows that high purity (99%) may be obtained if the purge step, t_{P}, is sufficiently increased.

Tables 3a, 3b and 4a show that for both 6 MMSCFD and 10 MMSCFD flow rate conditions, very high purity hydrogen at 99% and >85% recovery is achievable with the RCPSA. In both cases the tail gas is at 65 psig. Such high purities and recoveries of product gas achieved using the RCPSA with all the exhaust produced at high pressure have not been discovered before and are a key feature of the present invention.

Table 4c shows the results for an RCPSA (volume=49 cubic ft) that delivers high purity (>99%) H₂ at high recovery for the same refinery stream discussed in Tables 4a and 4b. As compared to Table 4a, Table 4c shows that similar purity and recovery rates can be achieved by simultaneously decreasing the duration of the feed cycle, t_{F}, and the purge cycle, tp.

TABLE 4c
Effect of step durations on H2 purity and recovery from an
RCPSA (49 ft³). Feed is at 480 psig, 101 deg F. and Tail
gas at 65 psig. Feed rate is about 10 MMSCFD.
Without counter-current depress

| Purity | Recovery | t_{F} | t_{CO} | t_{CN} | t_{P} | t_{RP} |
|---|---|---|---|---|---|---|
| % | % | s | S | S | s | s |
| 95.6 | 87.7 | 0.5 | 0.167 | 0 | 0.083 | 0.25 |
| 97.6 | 86 | 0.5 | 0.117 | 0 | 0.133 | 0.25 |
| 99.7 | 85.9 | 0.5 | 0.083 | 0 | 0.167 | 0.25 |

### EXAMPLE 4

In this example, Table 5 further illustrates the performance of RCPSA's operated in accordance with the invention being described here. In this example, the feed is a typical refinery stream and is at a pressure of 300 psig. The RCPSA of the present invention is able to produce 99% pure hydrogen product at 83.6% recovery when all the tail gas is exhausted at 40 psig. In this case the tail gas can be sent to a flash drum or other separator or other downstream refinery equipment without further compression requirement. Another important aspect of this invention is that the RCPSA also removes CO to <2 vppm, which is extremely desirable for refinery units that use the product hydrogen enriched stream. Lower levels of CO ensure that the catalysts in the downstream units operate without deterioration in activity over extended lengths. Conventional PSA cannot meet this CO specification and simultaneously also meet the condition of exhausting all the tail gas at the higher pressure, such as at typical fuel header pressure or the high pressure of other equipment that processes such RCPSA exhaust. Since all the tail gas is available at 40 psig or greater, no additional compression is required for integrating the RCPSA with refinery equipment.

TABLE 5
Composition (mol %) of input and output from RCPSA (4 ft³)
in carbon monoxide and hydrocarbon removal from hydrogen.
Feed is at 300 psig, 101 deg F., and Feed rate is about 0.97
MMSCFD.
Step Times in seconds are t_{F} = 0.5, t_{CO} = 0.1, t_{CN} = 0,
t_{P} = 0.033, t_{RP} = 0.066
H2 at 99.99% purity and 88% recovery

| | FEED | PRODUCT | TAIL-GAS |
|---|---|---|---|
| H2 | 89.2 | 99.98 | 48.8 |
| C1 | 3.3 | 0.01 | 13.9 |
| C2 | 2.8 | 0.01 | 13.9 |
| C3 | 2.0 | 0.00 | 10.2 |
| C4+ | 2.6 | 0.00 | 13.2 |
| CO | 50 | 1.1 | 198.4 |
| TOTAL | 0.971 | 0.760 | 0.211 |
| | 300 psig | 290 psig | 40 psig |

### EXAMPLE 5

Tables 6a and 6b compare the performance of RCPSA's operated in accordance with the invention being described here. The stream being purified has lower H₂ in the feed (51% mol) and is a typical refinery/petrochemical stream. In both cases (corresponding to Tables 6a and 6b), a counter current depressurization step is applied after the co-current step. In accordance with the invention, Table 6a shows that high H₂ recovery (81%) is possible even when all the tail gas is released at 65 psig or greater. In contrast, the RCPSA where some tail-gas is available as low as 5 psig, loses hydrogen in the counter-current depressurization such that H₂ recovery drops to 56%. In addition, the higher pressure of the stream in Table 6a indicates that no tail gas compression is required.

### Tables 6a and 6b

Effect of Tail Gas Pressure on recovery. Example of RCPSA applied to a feed with H2 concentration (51.3 mol %). Composition (mol %) of input and output from RCPSA (31 ft³) in H2 purification. Feed is at 273 psig, 122 deg F. and Feed rate is about 5.1 MMSCFD.

TABLE 6a
Step Times in seconds are t_{F} = 0.5, t_{CO} = 0.083,
t_{CN} = 0.033, t_{P} = 0.25, t_{RP} = 0.133
[A] Tail gas available from 65-83 psig, H2 at 99.7% purity and
81% recovery

| | FEED | PRODUCT | TAIL-GAS |
|---|---|---|---|
| H2 | 51.3 | 99.71 | 20.1 |
| C1 | 38.0 | 0.29 | 61.0 |
| C2 | 4.8 | 0.00 | 8.0 |
| C3 | 2.2 | 0.00 | 3.8 |
| C4+ | 3.7 | 0.00 | 6.4 |
| H2O | 4000 vppm | 0.7 vppm | 6643 vppm |
| TOTAL (MMSCFD) | 5.142 | 2.141 | 3.001 |
| | 273 psig | 263 psig | 65-83 psig |

TABLE 6b
Step Times in sec. are t_{F} = 0.667, t_{CO} = 0.167, t_{CN} = 0.083,
t_{P} = 0.083, t_{RP} = 0.33
[B] Tail gas available from 5-65 psig, H2 at 99.9% purity and
56% recovery

| | FEED | PRODUCT | TAIL-GAS |
|---|---|---|---|
| H2 | 51.3 | 99.99 | 34.2 |
| C1 | 38.0 | 0.01 | 48.8 |
| C2 | 4.8 | 0.00 | 6.9 |
| C3 | 2.2 | 0.00 | 3.4 |
| C4+ | 3.7 | 0.00 | 6.2 |
| H2O | 4000 vppm | 0.0 vppm | 5630 vppm |
| TOTAL (MMSCFD) | 5.142 | 1.490 | 3.651 |
| | 273 psig | 263 psig | 5-65 psig |

### EXAMPLE 6

In this example, Tables 7a and 7b compare the performance of RCPSA's operated in accordance with the invention being described here. In these cases, the feed pressure is 800 psig and tail gas is exhausted at either 65 psig or at 100 psig. The composition reflects typical impurities such H2S, which can be present in such refinery applications. As can be seen, high recovery (>80%) is observed in both cases with the high purity >99%. In both these cases, only a co-current depressurization is used and the effluent during this step is sent to other beds in the cycle. Tail gas only issues during the countercurrent purge step. Table 7c shows the case for an RCPSA operated where some of the tail gas is also exhausted in a countercurrent depressurization step following a co-current depressurization. The effluent of the co-current depressurization is of sufficient purity and pressure to be able to return it one of the other beds in the RCPSA vessel configuration that is part of this invention. Tail gas i.e., exhaust gas, issues during the counter-current depressurization and the counter-current purge steps.

In all cases the entire amount of tail gas is available at elevated pressure which allows for integration with other high pressure refinery process. This removes the need for any form of required compression while producing high purity gas at high recoveries. In accordance with the broad claims of this invention, these cases are only to be considered as illustrative examples and not limiting either to the refinery, petrochemical or processing location or even to the nature of the particular molecules being separated.

### Tables 7a, 7b, and 7c

Example of RCPSA applied to a high pressure feed. Composition (mol %) of input and output from RCPSA (18 ft³) in H2 purification. Feed is at 800 psig, 122 deg F. and Feed rate is about 10.1 MMSCFD.

TABLE 7a
Step Times in seconds are t_{F} = 0.91, t_{CO} = 0.25, t_{CN} = 0,
t_{P} = 0.33, t_{RP} = 0.33
[A] Tail gas at 65 psig, H2 at 99.9% purity and 87% recovery

| | FEED | PRODUCT | TAIL-GAS |
|---|---|---|---|
| H2 | 74.0 | 99.99 | 29.5 |
| C1 | 14.3 | 0.01 | 37.6 |
| C2 | 5.2 | 0.00 | 14.0 |
| C3 | 2.6 | 0.00 | 7.4 |
| C4+ | 3.9 | 0.00 | 10.9 |
| H20 | 20 vppm | 0 | 55 vppm |
| TOTAL (MMSCFD) | 10.187 | 6.524 | 3.663 |
| | 800 psig | 790 psig | 65 psig |

TABLE 7b
Step Times in seconds are t_{F} = 0.91, t_{CO} = 0.25, t_{CN} = 0,
t_{P} = 0.33, t_{RP} = 0.33
[B] Tail gas at 100 psig, H2 at 99.93% purity and 80.3% recovery

| | FEED | PRODUCT | TAIL-GAS |
|---|---|---|---|
| H2 | 74.0 | 99.93 | 38.1 |
| C1 | 14.3 | 0.07 | 32.8 |
| C2 | 5.2 | 0.00 | 12.5 |
| C3 | 2.6 | 0.00 | 6.5 |
| C4+ | 3.9 | 0.00 | 9.6 |
| H2S | 20 vppm | 0 vppm | 49 vppm |
| TOTAL (MMSCFD) | 10.187 | 6.062 | 4.125 |
| | 800 psig | 790 psig | 100 psig |

TABLE 7c
Step times in seconds are t_{F} = 0.91, t_{CO} = 0.83, t_{CN} = 0.25,
t_{P} = 0.167, t_{RP} = 0.41
[C] Tail gas at 65-100 psig, H2 at 99.8% purity and 84% recovery

| | FEED | PRODUCT | TAIL-GAS |
|---|---|---|---|
| H2 | 74.0 | 99.95 | 28.9 |
| C1 | 14.3 | 0.05 | 39.0 |
| C2 | 5.2 | 0.00 | 13.7 |
| C3 | 2.6 | 0.00 | 7.2 |
| C4+ | 3.9 | 0.00 | 10.6 |
| H2S | 20 vppm | 0.01 vppm | 53 vppm |
| TOTAL (MMSCFD) | 10.187 | 6.373 | 3.814 |
| | 800 psig | 790 psig | 65-100 psig |

### EXAMPLE 7

Tables 8a, 8b, and 8c compare the performance of RCPSA's operated in accordance with the invention being described here. The stream being purified has higher H₂ in the feed (85% mol) and is a typical refinery/petrochemical stream. In these examples the purity increase in product is below 10% (i.e. P/F<1.1). Under this constraint, the method of the present invention is able to produce hydrogen at >90% recovery without the need for tail gas compression.

### Tables 8a, 8b, and 8c

Example of RCPSA applied to a Feed with H2 concentration (85 mol %). Composition (mol %) of input and output from RCPSA (6.1 ft³). Feed is at 480 psig, 135 deg F. and Feed rate is about 6 MMSCFD.

TABLE 8a
Step Times in seconds are t_{F} = 0.5, t_{CO} = 0.33, t_{CN} = 0.167,
t_{P} = 0.167, t_{RP} = 1.83
recovery = 85%

| | FEED | PRODUCT | TAIL-GAS |
|---|---|---|---|
| H2 | 85.0 | 92.40 | 57.9 |
| C1 | 8.0 | 4.56 | 17.9 |
| C2 | 4.0 | 1.79 | 13.1 |
| C3 | 3.0 | 1.16 | 10.4 |
| C4+ | 0.0 | 0.00 | 0.0 |
| H2O | 2000 | 866.5 | 6915 |
| TOTAL (MMSCFD) | 6.100 | 4.780 | 1.320 |
| | 480 psig | 470 psig | 65 psig |

TABLE 8b
Step Times in sec. are t_{F} = 1, t_{CO} = 0.333, t_{CN} = 0.167,
t_{P} = 0.083, t_{RP} = 0.417
recovery = 90%

| | FEED | PRODUCT | TAIL-GAS |
|---|---|---|---|
| H2 | 85.0 | 90.90 | 58.2 |
| C1 | 8.0 | 5.47 | 18.1 |
| C2 | 4.0 | 2.23 | 12.9 |
| C3 | 3.0 | 1.29 | 10.1 |
| C4+ | 0.0 | 0.00 | 0.0 |
| H2O | 2000 | 1070.5 | 6823 |
| TOTAL (MMSCFD) | 6.120 | 5.150 | 0.969 |
| | 480 psig | 470 psig | 65 psig |

TABLE 8c
Step Times in sec. are t_{F} = 2, t_{CO} = 0.667, t_{CN} = 0.167,
t_{P} = 0.167, t_{RP} = 0.833
recovery = 90%

| | FEED | PRODUCT | TAIL-GAS |
|---|---|---|---|
| H2 | 85.0 | 90.19 | 55.2 |
| C1 | 8.0 | 6.21 | 18.8 |
| C2 | 4.0 | 2.32 | 13.9 |
| C3 | 3.0 | 1.17 | 11.3 |
| C4+ | 0.0 | 0.00 | 0.0 |
| H2O | 2000 | 1103.5 | 7447 |
| TOTAL (MMSCFD) | 6.138 | 5.208 | 0.93 |
| | 480 psig | 470 psig | 65 psig |

1. A process wherein the concentration of hydrogen is increased in a hydrogen-containing stream, which hydrogen-containing stream contains gaseous components other than hydrogen, which process comprises removing at least a portion of the gaseous components other than hydrogen from said hydrogen-containing stream in a rapid cycle pressure swing adsorption unit containing a plurality of adsorbent beds and having a total cycle time of less than about 30 seconds and a pressure drop within each adsorbent bed of greater than about 5 inches of water per foot of bed length, wherein said hydrogen is utilized in a petroleum refinery or petrochemical plant.

2. The process of claim 1 wherein the total cycle time is less than about 15 seconds.

3. The process of claim 2 wherein the total cycle time is less than about 10 seconds and the pressure drop is greater than about 10 inches of water per foot of bed length.

4. The process of claim 3 wherein the total cycle time is less than about 5 seconds.

5. The process of claim 4 wherein the pressure drop of greater than about 20 inches of water per foot of bed length.

6. The process of claim 1 wherein the hydrogen-containing stream is obtained from a hydrogen source that generates hydrogen by a chemical reaction and wherein light hydrocarbons are at least a portion of the gaseous components other than hydrogen.

7. The process of claim 6 wherein the hydrogen-containing stream is the product stream from steam reforming, catalytic cracking, partial oxidation and gasification of heavy hydrocarbons, thermal cracking or the net hydrogen stream from a catalytic reformer.

8. The process of claim 7 wherein the total cycle time is less than about 15 seconds.

9. The process of claim 8 wherein the total cycle time is less than about 10 seconds and the pressure drop is greater than about 10 inches of water per foot of bed length.

10. The process of claim 9 wherein the total cycle time is less than about 5 seconds.

11. The process of claim 10 wherein the pressure drop of greater than about 20 inches of water per foot of bed length.

12. The process of claim 4 wherein the hydrogen-containing stream is the off gas stream from a fluid catalytic cracking unit.

13. The process of claim 12 wherein the total cycle time is less than about 15 seconds.

14. The process of claim 13 wherein the total cycle time is less than about 10 seconds and the pressure drop is greater than about 10 inches of water per foot of bed length.

15. The process of claim 14 wherein the total cycle time is less than about 5 seconds.

16. The process of claim 15 wherein the pressure drop of greater than about 20 inches of water per foot of bed length.

17. The process of claim 1 wherein the hydrogen-containing stream is obtained from a hydrogen source that recovers hydrogen from one or more hydrogen-containing streams.

18. The process of claim 17 wherein the hydrogen-containing stream is obtained from a cryogenic unit, a membrane unit, or a pressure swing adsorption unit.

19. The process of claim 18 wherein the total cycle time is less than about 15 seconds.

20. The process of claim 19 wherein the total cycle time is less than about 10 seconds and the pressure drop is greater than about 10 inches of water per foot of bed length.

21. The process of claim 20 wherein the total cycle time is less than about 5 seconds.

22. The process of claim 21 wherein the pressure drop of greater than about 20 inches of water per foot of bed length.

23. A process wherein the concentration of hydrogen is increased in a hydrogen-containing stream obtained from a hydrogen source, which hydrogen-containing stream contains gaseous components other than hydrogen, which process comprises:
a) removing at least a portion of the gaseous components other than hydrogen from said hydrogen-containing stream in a rapid cycle pressure swing adsorption unit containing a plurality of adsorbent beds and having a total cycle time of less than about 30 seconds and a pressure drop within each adsorbent bed of greater than about 5 inches of water per foot of bed length; and
b) feeding said hydrogen-containing stream to a hydroprocessing process unit as a reactant.

24. The process of claim 23 wherein the hydroprocessing process unit is selected from the group consisting of a hydrotreating unit for removing heteroatoms from a hydrocarbon feed, a hydrocracking process unit wherein a hydrocarbon feed is converted to lower boiling liquid products, and a hydroisomerization unit wherein molecules of a hydrocarbon feed are isomerized.

25. The process of claim 24 wherein the hydrocarbon feed is selected from the group consisting of naphtha boiling range feeds, kerosene and jet fuel boiling range feeds, distillate boiling range feeds, resides and crudes.

26. The process of claim 25 wherein the hydrocarbon feed is a naphtha boiling range feed selected from the group consisting of straight run naphtha, cat cracked naphtha, coker naphtha, hydrocracker naphtha, resid hydrotreater naphtha.

27. The process of claim 25 wherein the total cycle time is less than about 15 seconds.

28. The process of claim 27 wherein the total cycle time is less than about 10 seconds and the pressure drop is greater than about 10 inches of water per foot of bed length.

29. The process of claim 28 wherein the total cycle time is less than about 5 seconds.

30. The process of claim 29 wherein the pressure drop of greater than about 20 inches of water per foot of bed length.
